(19) United States
(12) Patent Application Publication
(10) Pub. No.: US 2006/0215515 A1
(43) Pub. Date: Sep. 28, 2006

(54) Information recording/reproducing method and information recording/reproducing apparatus

(76) Inventors: Tsuyoshi Toda, Kodaira (JP); Toshiki Ishii, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/362,708

(22) Filed: Feb. 28, 2006

(30) Foreign Application Priority Data
Mar. 28, 2005 (JP) 2005-090462

(51) Int. Cl. G11B 7/12

(52) U.S. Cl. 369/47.53

(57) ABSTRACT

Random data is recorded on a higher-level recording layer and then, an optimum recording power is determined on a lower-level recording layer corresponding to the higher-level recording layer. Accordingly, it is necessary to record random data in more areas on the higher-level recording layer than areas for determining the optimum recording power on the lower-level recording layer. Consequently, there is a problem that the areas for determining the optimum recording power are excessively wasted. In the case of determining a recording condition for the lower-level recording layer corresponding to the recorded area on the higher-level recording layer, the recording condition for the lower-level recording layer corresponding to the recorded area on the higher-level recording layer can be easily determined by correcting the recording power using the change in transmittance that is obtained by comparing the case in which the data is recorded on the higher-level recording layer, with the case in which no data is recorded on the higher-level recording layer.

### BACKGROUND OF THE INVENTION

1. Field of the Invention

The present invention relates to an information recording/reproducing method of recording and reproducing information on and from an information recording medium, and particularly to an information recording/reproducing method of recording and reproducing information by using a laser beam.

2. Description of the Related Art

As a conventional method of determining an optimum recording laser power in an optical information recording/reproducing apparatus for recording and reproducing information on and from an optical recording medium having a plurality of recording layers such as a DVD-R disk having two layers on one side, random test data is recorded on a higher-level recording layer that is located closer to a laser beam incident surface, and then, the random test data is recorded on a lower-level recording layer that is located farther from the laser beam incident surface, so that the optimum recording laser power can be determined (refer to, for example, page 10 and FIG. 6 in Japanese Patent Application Laid-Open No. 2000-311346).

### SUMMARY OF THE INVENTION

However, since the random data is recorded on the higher-level recording layer and then, the optimum recording power is determined on the lower-level recording layer corresponding to the higher-level recording layer, it is necessary to record the random data in equal to or more areas on the higher-level recording layer than in areas for determining the optimum recording power for the lower-level recording layer. Therefore, there is a problem that the areas for determining the optimum recording power are excessively wasted on the higher-level recording layer.

Further, in the case where the optimum recording power cannot be determined on the lower-level recording layer corresponding to the areas on the higher-level recording layer on which the random data is recorded, there is also a problem of increasing processing time because it is necessary to determine the optimum recording power for the lower-level recording layer after the random data is recorded on the higher-level recording layer again.

In order to solve the foregoing problems, a recording condition for the higher-level recording layer and a recording condition for the lower-level recording layer without recording test data on the higher-level recording layer are determined, and the test data is recorded and reproduced on and from the lower-level recording layer without recording the test data on the higher-level recording layer by using the recording condition for the lower-level recording layer. A first reproduced signal level that has been obtained is temporarily stored in a memory of a controller or the like, and the test data is recorded in the areas on the higher-level recording layer corresponding to the test data areas on the lower-level recording layer or corresponding to about half of the test data areas on the lower-level recording layer. A second reproduced signal level is detected by reproducing the test data on the lower-level recording layer again and an optimum recording condition, as a recording condition for the lower-level recording layer with the test data recorded on the higher-level recording layer, is determined by correcting the recording condition for the lower-level recording layer without recording the test data on the higher-level recording layer, with the use of the ratio of the first reproduced signal level to the second reproduced signal level.

According to the present invention, it is possible to enhance the reliability of information recorded on an optical information recording medium by an optical information recording/reproducing apparatus. Further, it is possible to reduce processing time for determining a preferred recording condition.

### BRIEF DESCRIPTION OF THE DRAWINGS

Embodiments of the present invention will be described in detail based on the following figures, wherein:

FIG. 1 is a block diagram illustrating a configuration of an optical information recording/reproducing apparatus according to the present invention;

FIG. 2 is a diagram illustrating an example of a recording medium having a two-layered structure;

FIG. 3 is an explanatory diagram illustrating an example of data area and test area configurations on the recording medium having a two-layered structure;

FIG. 4 is a diagram illustrating a change in reproduced signal level on a second recording layer;

FIG. 5 is a block diagram illustrating a circuit configuration for detecting an amplitude level of a reproduced signal according to the present invention; and

FIG. 6 a block diagram illustrating a process flow according to the present invention.

### DETAILED DESCRIPTION OF THE PREFERRED EMBODIMENTS

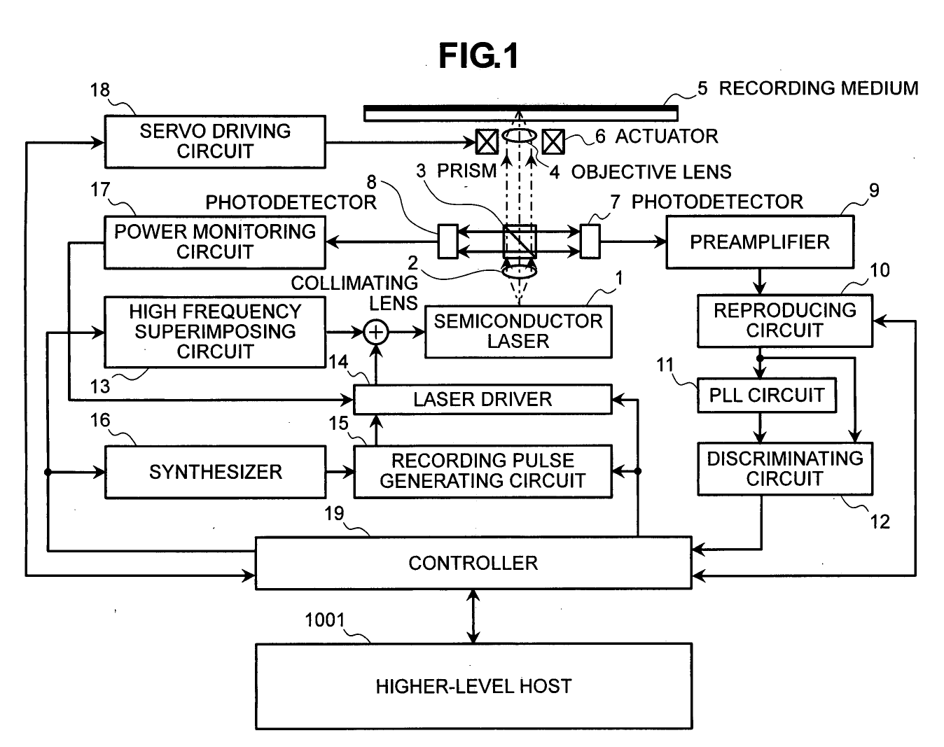

Hereinafter, embodiments of the present invention will be described in detail with reference to the drawings. First, FIG. 1 shows a configuration of an optical information recording/reproducing apparatus according to a first embodiment of the present invention. In FIG. 1, the numeral 1 denotes a semiconductor laser, 2 denotes a collimating lens which converts light output from the semiconductor laser into parallel light, 3 denotes a prism, 4 denotes an objective lens which forms a light spot on a disk by converging the laser beam, 5 denotes an optical disk which is a recording medium, 6 denotes an actuator for controlling the shape and position of the light spot formed on the recording medium 5, 7 and 8 respectively denote photodetectors, 9 denotes a preamplifier, 10 denotes a reproducing circuit, 11 denotes a PLL circuit, 12 denotes a discriminating circuit, 13 denotes a high frequency superimposing circuit, 14 denotes a laser driver, 15 denotes a recording pulse generating circuit, 16 denotes a synthesizer, 17 denotes a power monitoring circuit, 18 denotes a servo driving circuit, and 19 denotes a controller.

The optical information recording/reproducing apparatus having such a configuration is composed of an optical head which is mainly configured by the semiconductor laser 1, a record processing system which is mainly configured by the recording pulse generating circuit 15, and a reproduction processing system which is mainly configured by the reproducing circuit 10 that converts a reproduced signal obtained from the optical head, into information.

First, the basic operation of the apparatus according to the present invention will be described. The controller 19 decodes a command from a higher-level host 1001 or modulates recording data from the higher-level host 1001, and converts the same into code strings corresponding to the adapted modulation scheme. Further, the synthesizer 16 is an oscillator for generating a reference clock for the whole apparatus. In the case of adapting a recording method, as a method of making a disk large-capacity, called ZCAV (Zoned Constant Angular Velocity) by which the reference clock is changed for each zone so as to make the recording density substantially constant at the inner and outer circumferences, the oscillation frequency of the synthesizer 16 is changed in accordance with each zone. Alternatively, in the case of adapting another recording method called ZCLV (Zoned Constant Linear Velocity) by which the rotation speed of a spindle motor (not shown in the drawing) for rotating the recording medium 5 is changed so as to make the linear velocity substantially constant at the inner and outer circumferences, the oscillation frequency of the synthesizer 16 is fixed.

Further, in a servo mechanism (a focus servo and a tracking servo) for controlling the shape and position of a light spot to be used for recording and reproducing information, a focus error signal and a track error signal are obtained from, for example, a cylindrical lens (not shown in the drawing) arranged in front of the photodetector 7 and the photodetector (four elements) 7, and accordingly, the error signals are input (not shown in the drawing) into the controller 19. Further, the controller 19 outputs a servo signal to the servo driving circuit 18, and a driving current is supplied to the actuator 6. As a result, the objective lens 4 is moved so that the shape and position of the light spot can be controlled.

A recording process of information in the optical information recording/reproducing apparatus will be described. First, the code strings modulated in accordance with legitimate information data output from the controller 19 and the reference clock output from the synthesizer 16 are input into the recording pulse generating circuit 15 and then, converted into recording pulse strings for controlling the lengths and widths of recording marks.

Next, these recording pulse strings converted in the recording pulse generating circuit 15 are input into the laser driver 14 at first so as to allow the semiconductor laser 1 to generate high-power oscillation with a recording current that is supplied from the laser driver 14. The light output from the semiconductor laser 1 is converted into parallel light by passing through the collimating lens 2. Further, the parallel light passes through the prism 3 and is converged on the recording medium 5 by the objective lens 4, so that the recording marks in accordance with the code strings of the recording pulse strings are recorded.

In the meantime, the high frequency superimposing circuit 13 is provided in order to decrease laser noise derived from the semiconductor laser 1, and possibly suspends the high frequency superimposing in view of a laser lifetime on recording/deleting or overwriting information.

A reproducing process of information in the optical information recording/reproducing apparatus will be described. First, the semiconductor laser 1 is allowed to generate low-power oscillation, and the oscillated light is allowed to enter the recording medium 5. The optical path of reflective light from the recording medium 5 is separated by the prism 3 to enter the photodetector 7. The incident light is photoelectric-converted by the photodetector 7, and amplified by the preamlifier 9 to be input into the reproducing circuit 10. The reproducing circuit 10 is configured by, for example, a waveform equalizing circuit, an automatic gain controlling circuit, a binarizing circuit, and the like. Thereby, the reproduced signal being input is converted into a binarized signal. The reproducing circuit 10 includes a peak detection circuit 31 and a bottom detection circuit 32 for detecting an amplitude level of the reproduced signal as shown in FIG. 5.

As described above, the binarized signal output from the reproducing circuit 10 is then input into the PLL (Phase Locked Loop) circuit 11 for self-clocking. The reproduced clock, which is obtained by the PLL circuit 11 and which is synchronized with the binarized signal, and the binarized signal are input into the discriminating circuit 12 for data discrimination, and the data discrimination signal obtained as a result of discrimination is input into the controller 19, so that the data is demodulated.

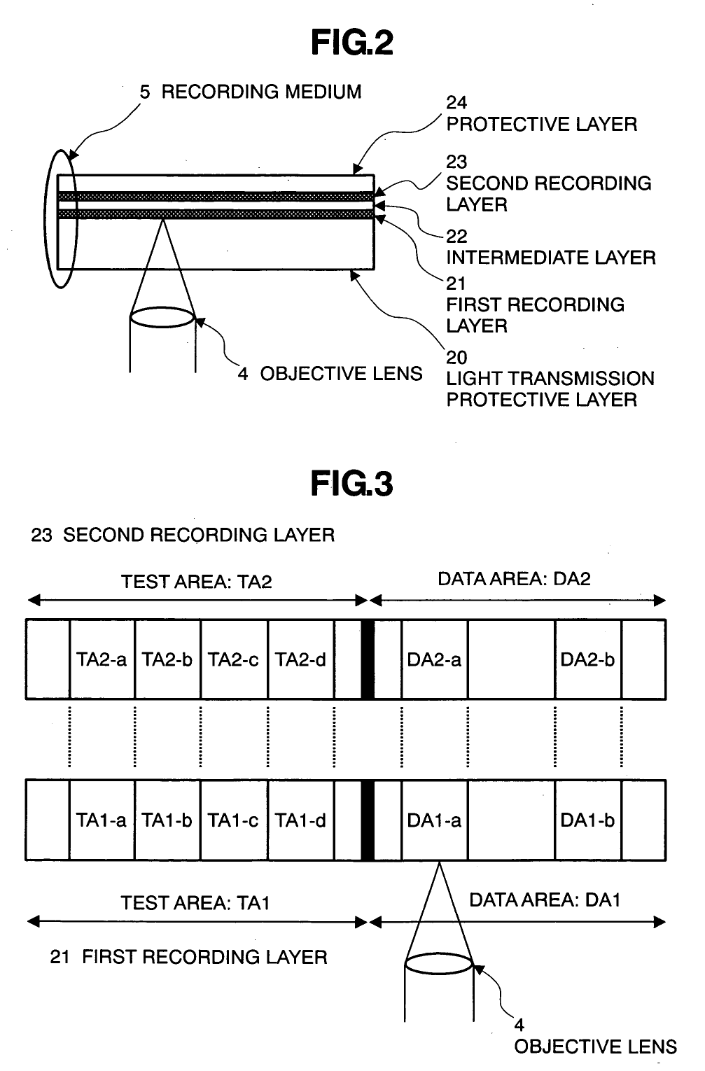

Next, the structure of the recording medium 5 having a multilayered structure will be described by using FIG. 2. The recording medium 5 is configured by a light transmission protective layer 20, a first recording layer 21 as a higher-level recording layer which is located closer to a laser beam incident surface, a second recording layer 23 as a lower-level recording layer which is located farther from the laser beam incident surface, an intermediate layer 22 which is provided between the first recording layer 21 and the second recording layer 23, and a protective layer 24. The laser beam converged by the objective lens 4 penetrates the light transmission protective layer 20, and reaches the first recording layer 21 and the second recording layer 23.

FIG. 3 is an explanatory diagram for showing an example of data area and test area configurations on the recording medium 5 having a double-layered structure. On the first recording layer 21, there are arranged a data area DA1, on which information is recorded, and a test area TA1, which is an area to be used for determining a recording condition for the first recording layer 21. Also on the second recording layer 23, a data area DA2 and a test area TA2 are arranged.

As shown in FIG. 3, the laser beam that has penetrated a test area TA1-a on the first recording layer 21 reaches a corresponding test area TA2-a on the second recording layer 23. As similar thereto, the laser beam that has penetrated areas TA1-b, TA1-c, TA1-d, DA1-a, and DA1-b on the first recording layer 21 reaches corresponding areas TA2-b, TA2-c, TA2-d, DA2-a, and DA2-b on the second recording layer 23.

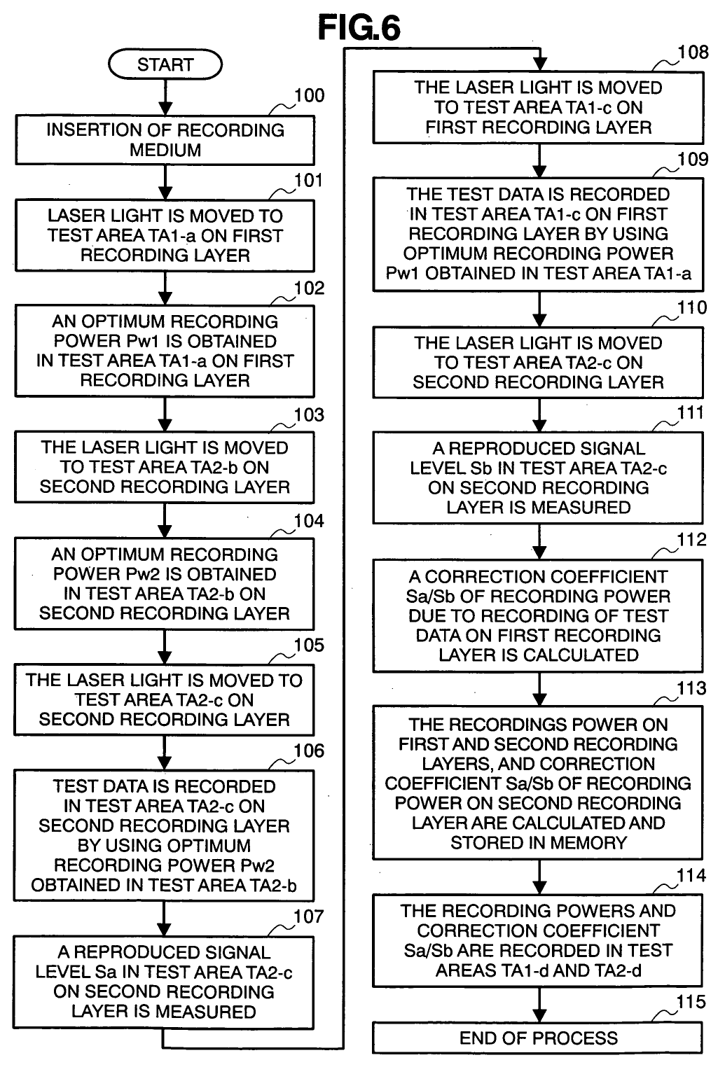

Next, in order to record information on the recording medium 5 having a double-layered structure in the information recording/reproducing apparatus, a process of determining an optimum recording power according to the present invention will be described by using a flowchart in FIG. 6.

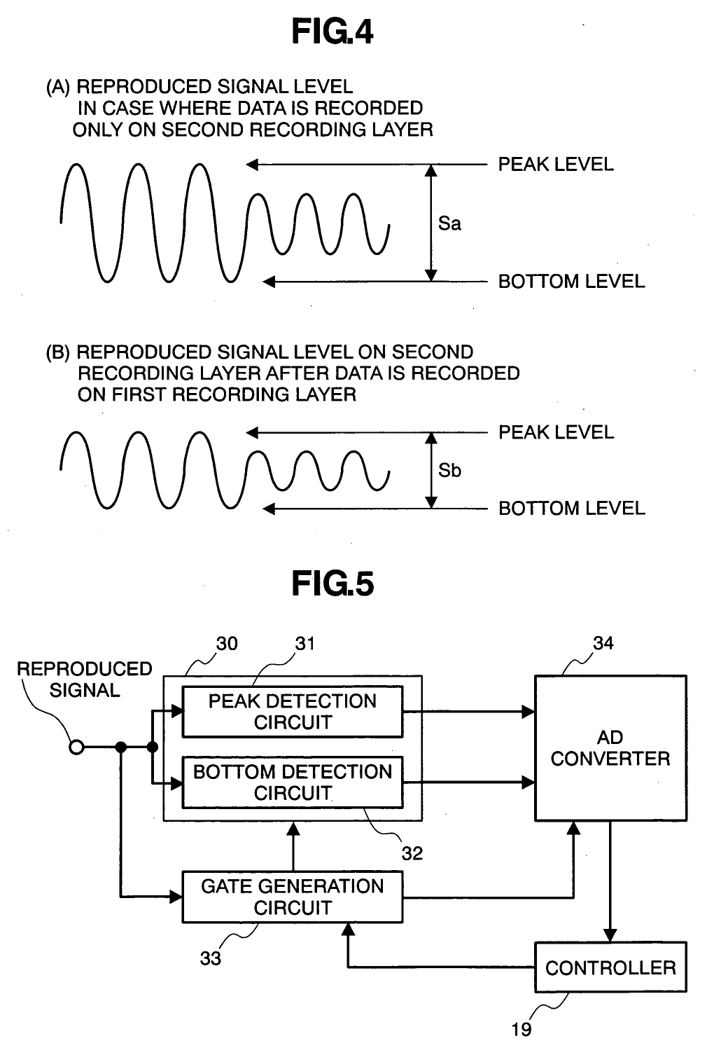

When a recording medium is inserted in Step 100, the information recording/reproducing apparatus allows the controller 19 to control so that the recording/reproducing operation can be performed by setting a rotation control, a servo control, and the like which are of initial setting. The laser beam is moved to the test area TA1-a on the first recording layer 21 in Step 101. An optimum recording power Pw1 is determined in the test area TA1-a in Step 102. The laser beam is moved to the test area TA2-b on the second recording layer 23 in Step 103, and an optimum recording power Pw2 is determined in the test area TA2-b in Step 104. Next, the laser beam is moved to the test area TA2-c on the second recording layer 23, and test data is recorded by using the optimum recording power Pw2 determined in the test area TA2-b. The test data recorded in the test area TA2-c is reproduced in Step 107, and a first reproduced signal level Sa is measured. The measurement of the reproduced signal level and the method thereof will be described later by using FIG. 4 and FIG. 5.

Next, the laser beam is moved to the test area TA1-c on the first recording layer 21 in Step 108, and the test data is recorded in the test area TA1-c in Step 109 by using the optimum recording power Pw1 determined in the test area TA1-a on the first recording layer 21. The laser beam is moved to the test area TA2-c on the second recording layer 23 again in Step 110, and the test data recorded in the test area TA2-c is reproduced again to measure a second reproduced signal level Sb in Step 111. In Step 112, a correction coefficient Sa/Sb corresponding to the change in transmittance due to the recording of the test data on the first recording layer 21 is calculated by the controller 19 using the ratio of the first reproduced signal level Sa to the second reproduced signal level Sb. In Step 114, the optimum recording powers Pw1 and Pw2, which are respectively determined on the first recording layer and the second recording layer, and the correction coefficient Sa/Sb are recorded in the test area TA1-d on the first recording layer 21 and the test area TA2-d on the second recording layer 23. Thereby, in the case where the recording medium 5 is inserted again, at least the correction coefficient Sa/Sb can be obtained by reading the information recorded in the test area TA1-d on the first recording layer 21 or the test area TA2-d on the second recording layer 23. Accordingly, the subsequent operations after Step 107 can be omitted by determining the optimum recording powers up to Step 106 in FIG. 6, and by using the correction coefficient Sa/Sb. Therefore, it is possible to reduce time required for optimizing the recording power for the second and subsequent times, to effectively use the test areas, and to prevent the test areas from being wasted.

Further, an alternative method of using the four test areas of TA1-c, TA1-d, TA2-c, and TA2-d that are described with reference to FIG. 6 will be described by using FIGS. 3 and 6. AS a method of measuring the change in transmittance without recording the test data each time, the test data is recorded in the two test areas of TA2-c and TA2-d, instead of recording the same only in the test area TA2-c, which is described in Step 106 of FIG. 6. Thereby, the first reproduced signal level Sa can be measured in the test area TA2-d and the second reproduced signal level Sb can be measured in the test area TA2-c, so that it is possible to reduce processing time required for determining the recording condition because once the test data is recoded, the correction coefficient Sa/Sb corresponding to the change in transmittance can be determined by just reproducing the same when the recording medium is inserted for the second and subsequent times.

Next, the measurement of the reproduced signal level and the method thereof according to the present invention will be described by using FIGS. 4A, 4B and 5. FIG. 4A shows a reproduced signal in the case of measuring the reproduced signal level Sa, which corresponds to Step 107 of the flowchart in FIG. 6. The reproduced signal level Sa can be obtained by measuring the peak level and the bottom level of the reproduced signal. FIG. 4B shows a reproduced signal in the case of measuring the reproduced signal level Sb, which corresponds to Step 111 of the flowchart in FIG. 6. FIG. 4B also shows a case in which the change in transmittance occurs due to the recording of the test data on the first recording layer and the transmittance of the first recording layer is decreased. In this case, it is necessary to correct the decrease in transmittance on the first recording layer, and accordingly, the optimum recording power for the second recording layer corresponding to the recoded area of the first recording layer can be determined by calculation using the recording power (Pw2 obtained in Step 104 of the flowchart in FIG. 6) for the second recording layer and the correction coefficient Sa/Sb. Further, there may be a case that some recording media are configured so that the transmittance is increased due to the recording of the test data on the first recording layer.

Next, a circuit configuration for detecting an amplitude level of the reproduced signal, of the reproducing circuit 10 will be described by using FIG. 5. The reproduced signal output from the preamplifier 9 branches differently from data discrimination within the reproducing circuit 10 and is input to an envelope detection circuit 30. Then, the peak level and the bottom level of the reproduced signal are detected by the peak detection circuit 31 and the bottom detection circuit 32. The amplitude level on the upper side of the drawing shown in each of FIGS. 4A and 4B is detected by the peak detection circuit 31 and the amplitude level on the lower side of the drawing shown in each of FIGS. 4A and 4B is detected by the bottom detection circuit 32.

On receiving a command from the controller 19, a gate generation circuit 33 controls the peak detection circuit 31, the bottom detection circuit 32, and an AD converter 34 in order to detect the peak level and the bottom level of the reproduced signal when a reproducing operation is performed right after recording data. The peak level and the center level supplied to the AD converter 34 are AD-converted and then, the converted amplitude data is stored in the controller 19. The controller 19 calculates the reproduced signal level Sa shown in FIG. 4A, the reproduced signal level Sb shown in FIG. 4B, and the correction coefficient Sa/Sb, and stores three kinds of recording powers, that is, the optimum recording power Pw1 for the first recording layer, the optimum recording power Pw2 for the second recording layer, and the optimum recording power Pw2×Sa/Sb for the second recording layer corresponding to the recorded area on the first recording layer, in a memory of the controller 19. Then, the controller 19 appropriately controls the laser driver 14.

Next, the setting of the recording power in recording information on the data areas according to the present invention will be described by using FIG. 3. The explanation will be given to the case of recording data in the four data areas of DA1-a, DA1-b, DA2-a, and DA2-b on the first and second recording layers as shown in FIG. 3 in the following order.

Recording order: DA1-a→DA2-b→DA1-b→DA2-a

In the case of recording information in the data area DA1-a, the information is recorded by using the optimum recording power Pw1 for the first recording layer. Next, in the case of recording information in the data area DA2-b, the information is recorded by using the optimum recording power Pw2 for the second recording layer. Next, in the case of recording information in the data area DA1-b, the information is recorded by using the optimum recording power Pw1 for the first recording layer, as similar to the case of the DA1-a. Next, in the case of recording information in the data area DA2-a, the information is recorded by using the optimum recording power Pw2×Sa/Sb for the second recording layer corresponding to the recorded area on the first recording layer because the information has already been recorded in the data area DA1-a.

As described above, in the case of recording information on the second recording layer, the recording power can be easily optimized by calculation using the recording power for the area on the second recording layer corresponding to the recorded area on the first recording layer and the correction coefficient Sa/Sb.

The present invention has been described with the example of the multilayered structure having two recording films. However, in the case of the multilayered structure having more than two recording films, the correction coefficient with respect to the change in transmittance is merely increased due to the relation between the higher-level recording layer and the lower-level recording layer. Accordingly, the optimum recording power can be easily determined in consideration of the change in transmittance of the higher-level recording layer by using the correction coefficient.

The foregoing invention has been described in terms of preferred embodiments. However, those skilled, in the art will recognize that many variations of such embodiments exist. Such variations are intended to be within the scope of the present invention and the appended claims.

What is claimed is:

1. An information recording and reproducing method for recording information by irradiating, with a laser beam, a recording medium having a plurality of recording layers and by forming recording portions, which are different in physical property from unrecording portions for information, in recording areas on the recording layers, the respective recording layers comprising data areas for recording information and test areas for determining recording conditions, the method comprising the steps of:
when the recording condition for a lower-level recording layer that is located farther from a laser beam incident surface is determined after the recording condition for the test area on a higher-level recording layer that is located closer to the laser beam incident surface is determined,
determining the recording condition for the lower-level recording layer in the test area on the lower-level recording layer that corresponds to the test area, in which no information is recorded, on the higher-level recording layer;
recording the test data in another test area on the lower-level recording layer under the recording condition for the lower-level recording layer;
obtaining a first reproduced signal level;
recording the test data in the test area on the higher-level recording layer that corresponds to the test area, in which the test data is recorded, on the lower-level recording layer;
obtaining a second reproduced signal level of the test data on the lower-level recording layer;
correcting the recording condition for the lower-level recording layer in the case where the test data is recorded on the higher-level recording layer, by using the ratio of the first reproduced signal level to the second reproduced signal level; and
correcting the recording condition for the lower-level recording layer by using the ratio of the first reproduced signal level to the second reproduced signal level if the test data has been recorded on the higher-level recording layer.

2. The information recording and reproducing method according to claim 1, further comprising the steps of:
when information is recorded on the lower-level recording layer that corresponds to the area, in which the data is recorded, on the higher-level recording layer,
correcting the recording condition for the lower-level recording layer in the case of not recording the test data on the higher-level recording layer, by using the ratio of the first reproduced signal level to the second reproduced signal level; and
recording the information on the information recording medium.

3. An information recording and reproducing apparatus for an optical disk having a first recording layer on and from which information is recorded and reproduced with a laser beam that enters from a first surface of the optical disk and a second recording layer on and from which information is recorded and reproduced with the laser beam that has penetrated the first recording layer, said apparatus comprising:
an optical head for recording and reproducing information by irradiating, with the laser beam, said first recording layer or said second recording layer; and
control means for controlling the optical head, wherein
said control means obtains a first reproduced signal level by recording and reproducing test data in and from a second test area on said second recording layer, records the test data in a first test area which is located on said first recording layer and which the laser beam penetrates when recording the test data in said second test area, obtains a second reproduced signal level by reproducing the test data recorded in said second test area with the laser beam that has penetrated the first test area in which the test data is recorded, and corrects and detects the reproduced signal on the second recording layer by using said first reproduced signal level and said second reproduced signal level, said reproduced signal having penetrated the area, in which the data is recorded, on the first recording layer.

4. An information recording and reproducing apparatus for an optical disk having a first recording layer on and from which information is recorded and reproduced with a laser beam that enters from a first surface of the optical disk and a second recording layer on and from which information is recorded and reproduced with the laser beam that has penetrated the first recording layer, said apparatus comprising:
an optical head for recording and reproducing information by irradiating, with the laser beam, said first recording layer or said second recording layer; and
control means for controlling the optical head,
wherein said control means obtains a first reproduced signal level by recording and reproducing test data in and from a second test area on said second recording layer, records the test data in a first test area which is located on said first recording layer and which corresponds to said second test area, obtains a second reproduced signal level by reproducing the test data recorded in said second test area with the laser beam that has penetrated the first test area in which the test data is recorded, and corrects and detects the reproduced signal on the second recording layer by using said first reproduced signal level and said second reproduced signal level, said reproduced signal having penetrated the area, in which the data is recorded, on the first recording layer.

5. The information recording and reproducing apparatus according to claim 3 or 4, wherein
the recording of the test data in said first test area is performed using a laser power determined by recording the test data in a third test area on the first recording layer, and the recording of the test data in said second test area is performed using a laser power obtained by recording the test data in a fourth test area on the second recording layer.

6. An information recording and reproducing method for an optical disk having a first recording layer on and from which information is recorded and reproduced with a laser beam that enters from a first surface of the optical disk and a second recording layer on and from which information is recorded and reproduced with the laser beam that has penetrated the first recording layer, said method comprising the steps of:
obtaining a first reproduced signal level by recording and reproducing test data in and from a second test area on said second recording layer;
recording the test data in a first test area which is located on said first recording layer and which the laser beam penetrates when recording the test data in said second test area;
obtaining a second reproduced signal level by reproducing the test data recorded in said second test area with the laser beam that has penetrated the first test area in which the test data is recorded; and
correcting and detecting the reproduced signal on the second recording layer by using said first reproduced signal level and said second reproduced signal level, said reproduced signal having penetrated the area, in which the data is recorded, on the first recording layer.

7. An information recording and reproducing method for an optical disk having a first recording layer on and from which information is recorded and reproduced with a laser beam that enters from a first surface of the optical disk and a second recording layer on and from which information is recorded and reproduced with the laser beam that has penetrated the first recording layer, said method comprising the steps of:
obtaining a first reproduced signal level by recording and reproducing test data in and from a second test area on said second recording layer;
recording the test data in a first test area which is located on said first recording layer and which corresponds to said second test area;
obtaining a second reproduced signal level by reproducing the test data recorded in said second test area with the laser beam that has penetrated the first test area in which the test data is recorded; and
correcting and detecting the reproduced signal on the second recording layer by using said first reproduced signal level and said second reproduced signal level, said reproduced signal having penetrated the area, in which the test data is recorded, on the first recording layer.

8. The information recording and reproducing method according to claim 6 or 7, wherein
the recording of the test data in said first test area is performed using a laser power determined by recording the test data in a third test area on the first recording layer, and the recording of the test data in said second test area is performed using a laser power obtained by recording the test data in a fourth test area on the second recording layer.
